(19) United States
(12) Patent Application Publication
(10) Pub. No.: US 2014/0307735 A1
(43) Pub. Date: Oct. 16, 2014

(54) MODEL FOR MANAGING THE PROCESSES AROUND THE BROADCASTING OF PHONE CALLS AND TEXT MESSAGES TO GROUPS OF PEOPLE

(71) Applicant: YakStack, LLC, Bound Brook, NJ (US)

(72) Inventor: Steven Lerner, Bound Brook, NJ (US)

(73) Assignee: YakStack, LLC, Bound Brook, NJ (US)

(21) Appl. No.: 14/251,185

(22) Filed: Apr. 11, 2014

Related U.S. Application Data
(60) Provisional application No. 61/948,500, filed on Mar. 5, 2014.
(60) Provisional application No. 61/810,866, filed on Apr. 11, 2013.

(51) Int. Cl. H04L 12/18; H04L 12/931

(52) U.S. Cl. CPC H04L 12/189; H04L 12/185; H04L 12/1859; H04L 49/201
USPC 370/390

(57) ABSTRACT

The present disclosure provides for methodologies for mass electronic communications. This is achieved using a third party site (website) where users can control contact preferences and subscribe, or opt-in, to receive certain communicational content. A user can then upload a voice message or textual/image based message which is then delivered, via the website, to the intended recipients. Authenticated users of the site can allow their personal information to remain private, while still receiving such communications.

### CLAIM OF PRIORITY

This application claims priority to U.S. Application Ser. No. 61/948,500 filed on Mar. 5, 2014 and to U.S. Application Ser. No. 61/810,866 filed on Apr. 11, 2013, the contents of both of which are fully incorporated by reference in their entirety.

### FIELD OF THE INVENTION

The field of the invention relates to a method for managing the broadcasting of electronic messages to groups of people, namely providing a secure third party to facilitate transmission of the electronic messages. In particular, to providing a website/mobile application that offers various message feeds to which users can subscribe or opt-in to and gain access to content via an electronic device.

### BACKGROUND OF THE INVENTION

Varying forms of electronic communication and its usage has seen a sharp increase in recent years. This is largely attributable to the increase in access to the internet or internet compatible devices, as well as the social media platforms they host. These devices have progressed to the point such that formerly carrying items with similar functionality was not practical, but has now become virtually required by society. As such, it is now easier to communicate with another person than ever before. However, even with these advances there are still a number of drawbacks to large scale electronic communications.

Current platforms, or models, for managing the innumerable processes involving the broadcasting of large scale electronic communications are limited in a number of manners. In order to presently send such a message (textual, voice, etc.) the sender must acquire and maintain an extensive contact list including phone numbers for the desired contacts. This means the sender must be up to date on people's current phone number, their desire to be contacted, and the time and manner of the electronic communications. Even further, most potential recipients have an overwhelming desire for security and control over their personal information. Many companies regularly disseminate personal data collected to other companies or entities. This can often happen without a person realizing they ever gave permission for such disclosures to occur. In the same vein, many times consumers have no interest in speaking with a particular solicitor and have virtually no control over when and how they may attempt to contact them.

Thus, there is a need for a system and method that enables wide range electronic communications over a variety of mobile and non-mobile platforms. Further, by executing this methodology through a third party, it relieves much of the burden faced by prior methods by having to continually maintain contact lists and preferences. In turn, the user's information can also be kept private since the third party controls the verification process and dictates who receives or sends what content based on user determined preferences.

### Review of Related Technology:

U.S. Pat. No. 7,900,247 describes trusted third party authentication for Web services. Web services trust and delegate user authentication responsibility to a trusted third party that acts as an identity provider for the trusting Web services. The trusted third party authenticates users through common authentication mechanisms, such as, for example, username/password and X.509 certificates and uses initial user authentication to bootstrap subsequent secure sessions with Web services. Web services construct user identity context using a service session token issued by the trusted third party and reconstruct security states without having to use a service-side distributed cache.

U.S. Pat. No. 6,760,841 describes a transaction processing system that employs an authentication device which receives identifying and authentication information from a token such as a credit or debit card. The authentication device forms an information block comprising the identifying and authentication information and encrypts the information block using a preprogrammed key. The information block is transferred to a transaction terminal such as a merchant terminal or customer computer and subsequently transferred to an authorizing server.

The authorizing server transfers the information block to an authenticating server, which decrypts the information block, extracts the identifying and authentication information and compares the identifying and authentication information against similar information accessible to the authenticating server. The authenticating server instructs the authorizing server to accept or reject the transaction based on the result of the comparison. Alternatively, a self-authenticating token may be employed in which authentication information characteristic of the token is converted to a numerical format, encrypted and stored on the token. The authentication device decrypts the numerical representation of the authentication information and compares it against the actual authentication information. The authentication device accepts or rejects the transaction based on the result of the comparison.

Various devices are known in the art. However, their structure and means of operation are substantially different from the present disclosure. The other inventions also fail to solve all the problems taught by the present disclosure. The present disclosure provides for a methodology that employs a trusted third party to effectively broadcast mass electronic communications that can be received by individual users running a variety of electronic platforms. Additionally, the user's information, such as email address and phone number, can remain private. At least one embodiment of this invention is presented in the drawings below and will be described in more detail herein.

### SUMMARY OF THE INVENTION

The present disclosure generally describes methodologies for users to send and receive mass electronic communications through a secure third party. Authenticated users of the service can “opt-in” to receive content from particular individuals, groups, companies, etc. This is achieved by a method of managing broadcast messaging to individual subscribers or groups of subscribers having the steps of at least one user creating a new account associated with an electronic device to manage incoming and outgoing broadcast messages; verifying the authenticity of the new account, wherein verification is completed via response to an automated message and after a predetermined time a nonresponsive account is removed from the system; receiving user preferences associated with the new account; verifying the user has a verified phone number associated with their account; generating an open or closed broadcast message in accordance with the user preferences, wherein the open broadcast message can be subscribed to by any user and the closed broadcast message can only be subscribed to by verified users; and providing a medium for the open or closed broadcast message to be transmitted.

In another aspect of the invention there is a method of a user receiving broadcast messages via at least one electronic device comprising the steps of creating a new account associated with the at least one electronic device to manage incoming broadcast messages; subscribing to at least one broadcast message feed, wherein the user may manually subscribe to the broadcast message feed or wherein the user may receive an invitation to subscribe to the broadcast message feed; indicating the manner and mode of delivery of the broadcast messages; receiving a notification of the broadcast messages from one of the at least one broadcast message feeds; and accessing the broadcast message via the at least one electronic device, wherein the broadcast message may be audio, visual, or audiovisual in nature.

In yet another aspect of the invention, there is method of creating a broadcast message feed having the steps of a user creating an account on a system website to manage the broadcast message feed; creating a new broadcast message feed associated with the account, wherein the broadcast message feed is assigned a unique URL and wherein the broadcast message feed can be designated as open or closed; and creating a new broadcast message to distribute to the subscribers of the new broadcast message feed.

Generally, the present invention is a web or mobile application that allows a user to disseminate information to group(s) of people. Once a user has signed up and/or downloaded any requisite files, the user can begin using the system. The user can then create custom message feeds that can be sent to any person or persons who desires to receive them. For example, a coach of a sports team can create a custom news feed for the team that he coaches. Parents of players can then sign up or opt to follow his/her feed and receive messages from the coach. Thus, if the game is canceled due to inclement weather, notifications will automatically go out to the subscribers of the feed. The receivers may get a SMS message or voicemail message or email message. This enables a quick and reliable method of disseminating information. The coach, in the above example, only has to create the message once, and it is then sent automatically to any number of followers of the feed. This removes the need for any number of back and forth phone calls between the coach and parents. The method and associated system may be applicable to any number of settings including schools, athletic teams, businesses, and any other type of group where communication is of most importance. Further, the methods and system provide an avenue for those to opt-out of receiving notifications associated with subscribed to feeds.

In general, the present invention succeeds in conferring the following, and others not mentioned, benefits and objectives.

It is an object of the present invention to provide a method of broadcasting electronic communications, including phone calls, which can be directed to particular electronic devices.

It is an object of the present invention to provide a method of broadcasting electronic communications that are distributed via a third party.

It is an object of the present invention to provide a method of broadcasting electronic communications which limit by who they can be received or accessed.

It is an object of the present invention to provide a method of broadcasting electronic communications that interact with a number of electronic devices.

It is an object of the present invention to provide a method of broadcasting electronic communications that verifies client account information to limit the occurrence of fake or inactive accounts.

It is an object of the present invention to provide a method of broadcasting electronic communications that provides a similar interface across platforms thereby creating a seamless user experience.

It is another object of the present invention to provide a method of broadcasting electronic communications that allows user's information to remain private.

It is another object of the present invention to provide a method of broadcasting electronic communications that provides for an effective method of timely information delivery.

It is yet another object of the present invention to provide a method of broadcasting electronic communications that enables communications to be distributed to large group sizes such as offices or schools.

### BRIEF DESCRIPTION OF THE DRAWINGS

FIG. 1 is a graphical view of a high level system architecture of the present invention.

FIG. 2 is a flowchart illustrating a number of methodologies associated with signing up for the services attributable to the present invention.

FIG. 3 is a flowchart illustrating the process to activate a telephone to receive messages from the web application of the present invention.

FIG. 4 is a flowchart illustrating the process to create a custom feed in accordance with the present invention.

FIG. 5 is a flowchart illustrating the process to record and deliver feed messages.

### DETAILED DESCRIPTION OF THE DRAWINGS

The preferred embodiments of the present invention will now be described with reference to the drawings. Identical elements in the various figures are identified, as far as possible, with the same reference numerals. Reference will now be made in detail to embodiments of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto without deviating from the innovative concepts of the invention.

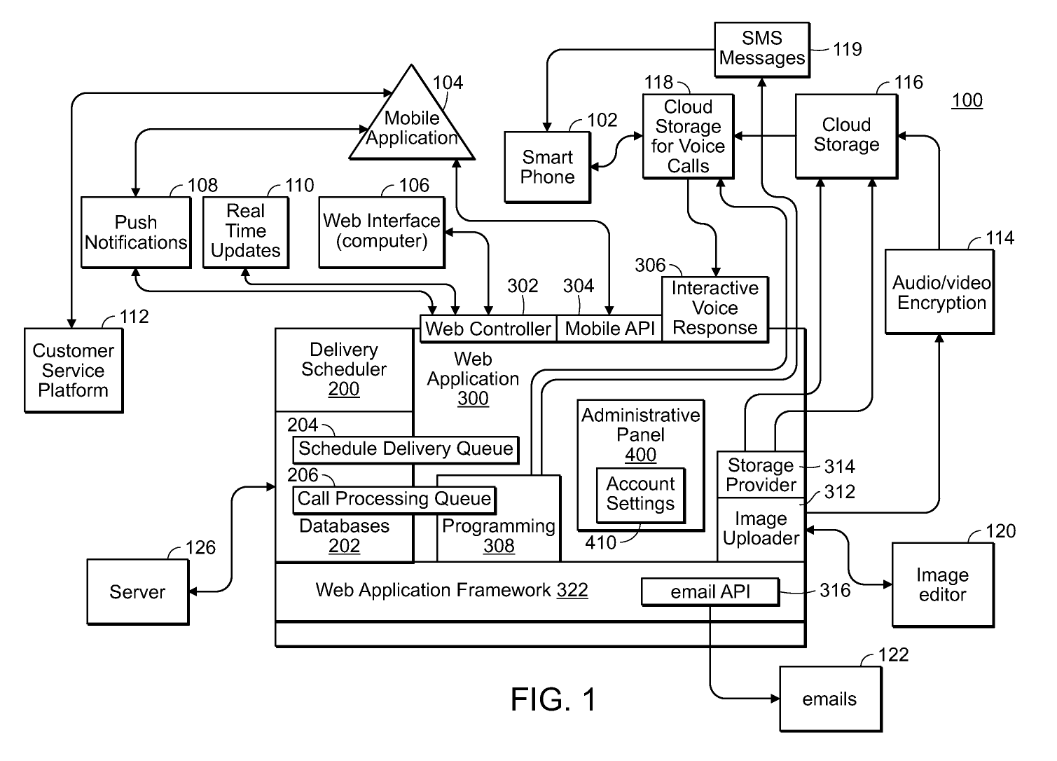

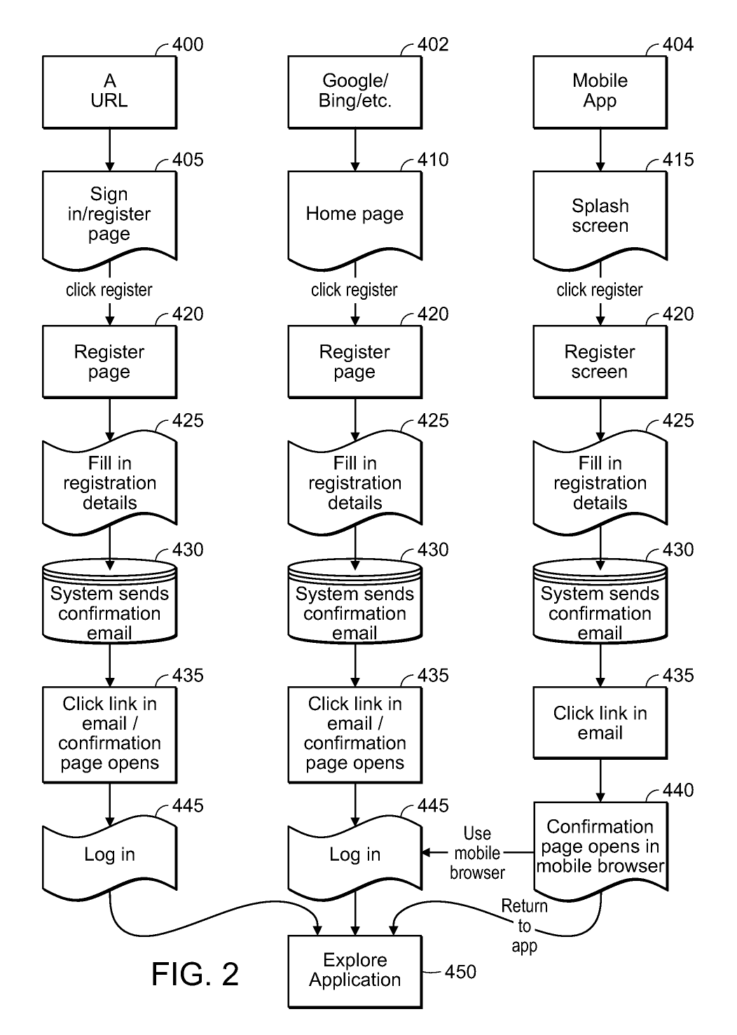

Referring to FIG. 1, there is a high level system overview 100 of the present invention. The system 100 can interact with a number of interfaces including telephonic (smart phone) 102, a mobile application 104, and a web based interface (computer) 106. The system 100 has three main parts: the delivery scheduler 200, web application 300, and the administrative panel 400. In order to use the system 100, a user must create and confirm a registration with the website (see FIG. 2). Once that has been accomplished, access to the site can be attained from at least the interfaces listed above. The user can then access the admin panel 400. In block 410 the user can then make any number of changes to their account including username, password, associated contact information, and the like. Further, the user can add images to their profile such as a “profile picture” through an image uploading API in block 312. The image can then be manipulated, or edited, through box 120 and then saved to box 312 to serve as the user's profile picture. The image files and other pertinent files can then be stored through a storage provider in box 314. The information can then travel one of two paths to either box 116 or to box 114 then box 116.

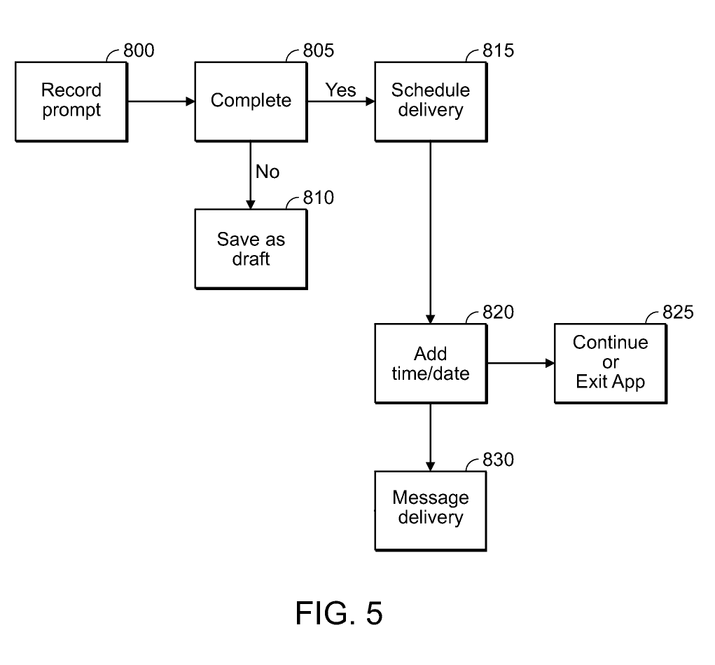

Audio process requests can be sent to an audio and/or video encryption/decryption service in box 114. Alternatively, any such images or audio files can bypass the encryption/decryption service and be stored in a cloud storage offering 116. The audio files can then be delivered to box 118, a cloud storage for voice calls. This allows the users to interact with the stored phone messages. The stored messages can be programmed to enable user interaction (i.e. press 1 to repeat the voice message). Further, these messages can be directly accessed from a user's mobile phone or smart phone 102. In box 308, there exist potential programming options for communicating with the audio cloud storage 118. Such options include various programs and assistance with the inclusion of these programs. In a box 119, SMS messages are sent to the smart phone 102 where they may be accessed. The SMS messages 119 are generated by the programming block 308. The SMS messages 119 may be sent immediately after creation or sent at a later time and date in accordance with the receiver's settings (see FIG. 5).

One component of the web application 300 is the delivery scheduler 200. The delivery scheduler 200 has a number of databases 202 that work in conjunction with one another to store job queues, such as phone calls to be delivered, and then coordinates their delivery upon the appropriate time. There is a schedule delivery queue 204 that aligns jobs sent to the delivery scheduler 200 and a call processing queue 206. The delivery scheduler 200 works in conjunction with a server 126 such as a redis server, which supplies a highly scalable data store for use within the system. The web application 300 and delivery scheduler 200 are run by any number of web application frameworks 322. These frameworks include programming that permit the sending of email from the web application 300 such as box 316. The emails 122 sent by the framework 322 may be any type of email and may be related to transactional type emails such as confirming new user signups, shipping details, and the like.

The web application 300 hosts the various controllers such as a web controller 302, mobile API 304, and controller for an interactive voice response 306. The mobile API 304 enables mobile access via a mobile application 104 run on a smart phone. The mobile application 104 may be able to interact with a customer service platform 112 to provide assistance to users. The web controllers 302 may generate push notifications 108 that a mobile user receives on the mobile application 104. A push notification is an alert generated on an electronic device, such as a smartphone, by a third party server. A user may also use a laptop computer, desktop computer or the like 106 to access the web application 300. The web application 300 permits for the use of real time updates in a box 110. These updates can then be received by the user running the web application 300.

FIG. 2 is a flowchart illustrating the sign up process for the web application. A user must first access the web application which can be achieved in a number of ways. A user can click a link (URL) from an existing user of the web application 400 which will take them to the particular web application feed. If upon arrival at the web application, it is detected that the user is not a registered user, the user will be prompted with a sign up/register option 405. A user may also reach the web application through a search engine such as Google or Bing 402. Following a link from the gathered search results will take a user to the web application's homepage 410 which bears a log-in/sign up option. A user may also be using a mobile platform such as a tablet or smart phone to access the web application through a mobile application 404. The user is then greeted with a splash screen 415 which has a register/log-in option.

From any of the above options, the user may decide to register in order to use the web or mobile application. The user clicks or selects the register button and is greeted with a new user registration screen 420. Regardless of the platform, the user must then fill in the required registration details 425 such as name, age, gender, address, email, phone number, and the like. Not all prompted fields may be required and those fields which are required will be denoted to distinguish themselves from the optional prompted fields. The web or mobile application, upon a proper registration, will send a confirmation email to the supplied email given in the application registration 430. The user opens their email and clicks the automatically generated link contained within the email. 435. This verifies the email address supplied is valid and should ensure that the email belongs to the correct individual. The users accessing the web application can then log-in 445 and can then begin using the application to opt-in to receive content from certain feeds 450. A mobile user may first have a page open in their mobile browser 440. The user can then decide whether to use their mobile browser to log in 445 or can return to the app 450.

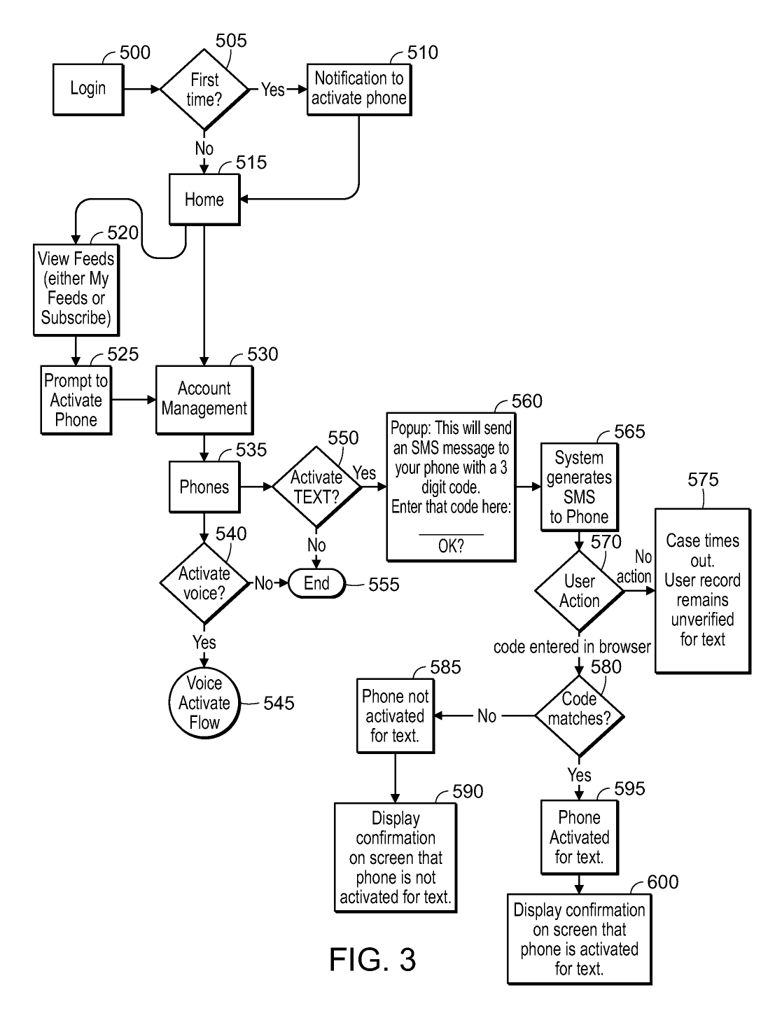

FIG. 3 illustrates the process for activating one's telephone to operate in conjunction with and receive messages from the web application of the present invention. Initially, a user will log-in to the web application 500. In a box 505, it is then ascertained whether this is a user's first time logging into the system. If this is the user's first time, then the process is directed to box 510, where the user receives a notification to activate their phone. Upon completion, the process is directed to box 515, the home menu. If it was previously a user's at least second time accessing the system on that electronic device, box 510 is bypassed and the user is brought directly to the home screen in box 515.

In a box 520, the user is given the option to view a number of feeds. These feeds may comprise the user's own feeds or feeds that the user has opted or subscribed to receive content. If the electronic device, such as a telephone, has not yet been activated the user will receive a prompt, as shown in box 525, to activate the telephone. The user will then be brought to an account management screen 530. Additionally, a user may choose to bypass the feed view and navigate directly to the account management screen 530. At the account management screen 530, the user can see a visual depiction of the various telephones associated with their particular account 535. The user can then either choose to activate voice messages 540 or activate text messages 550. A user may also choose to do both, although these processes may be required to be performed separately. If the user chooses to activate the voice messages 540, the voice flow is activated in box 545. If the user declines, the user is given the option to activate the text 550. Declining to proceed with either option will end 555 the session and redirect the user back to the main page of the application.

If the user selects to activate the textual messages from the web application, the user will receive a popup to input a multi-digit code, a representation of which is shown in box 560. In a box 565, the system generates an SMS to the user's phone. In a box 570, the user receives the code and it is either entered or not entered into the previously generated popup. If the user takes no action, the multi-digit codes times out, or expires, and the user does not complete the textual set-up. If the code is entered by the user, the system checks the code in a box 580 for accuracy. If the code was incorrectly entered 585, there will be a display page that alerts the user to the inaccuracy and may prompt them to try entering the code again 590. If the code is entered correctly 595, the phone is then activated and ready to receive text messages. A display will confirm that the phone has been activated and it will be added to the system for subsequent use 600.

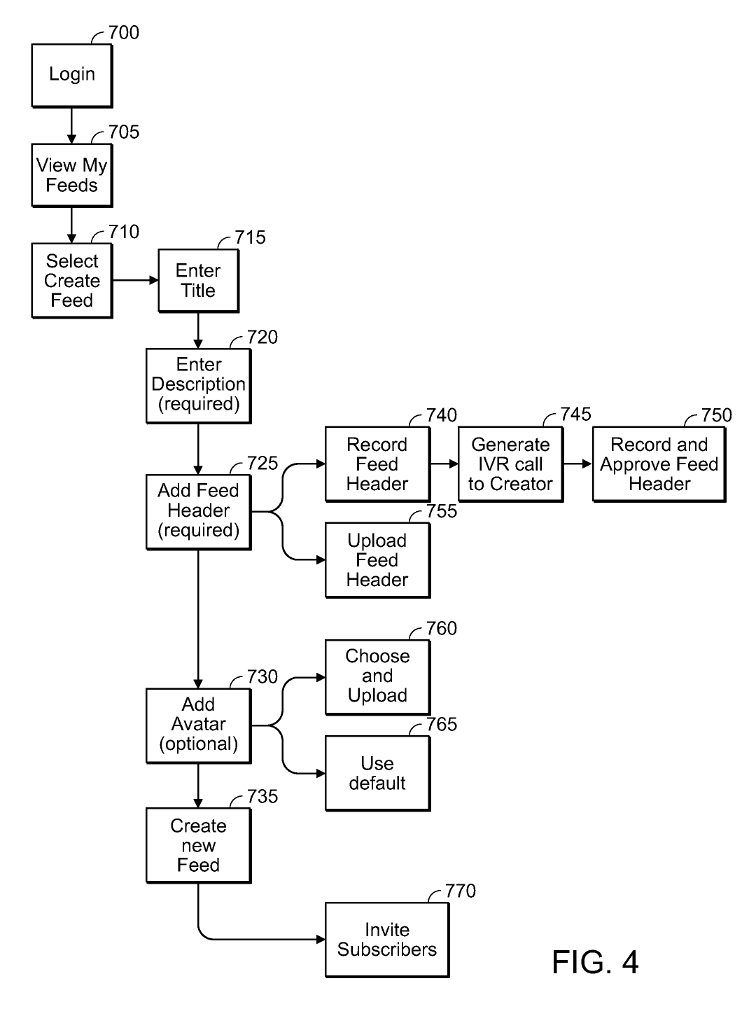

In FIG. 4, once the user has completed the steps in FIG. 3, the user can create their own feed for disseminating voice or textual based messages to their potential subscribers. To create a custom feed, a user logs in to the system 700 via a web or mobile device. The user then selects to “view my feeds” 705 to view the list of feeds the user has created. From the available options, the user selects “create new feed” 710. In order to proceed with the feed creation, the user must have a valid phone number activated in their account (see FIG. 3). The user is then brought through a series of steps with the aid of the system to create a new custom feed. The user is then prompted to enter a title 715 for the new feed. Preferably the title is a description of the feed content, although the title can be virtually any combination of characters. The user can then enter a description 720 to describe the content of the feed. The content of the feed may include items such as updates to schedules (sporting, music, etc.) or other noteworthy communications.

The user can now create a feed header 725. The feed header introduces the feed with a voice greeting. The user records the feed header 740. The recorded header generates an interactive voice response call to the creator 745. In a box 750 the user can then approve of the header or decide to delete and re-record the header using prompts (i.e. press “1” to save) supplied by the software. The user can repeat his process as many times as needed. Once satisfied with the header, the user can upload the feed header to the feed 755. Optionally, a user can create a custom avatar 730 that other users can view upon visiting the creator's feed. The user may choose to take a picture of themselves, or upload any picture to the system to be used as their avatar 760. Alternatively, in box 765, the user may simply use one of the default avatars supplied by the application. The user can proceed to finish the set up and has now completed the process to create a new feed 735.

Once the feed has been created, the feed creator or content provider can invite subscribers 770 to subscribe to, or opt-in to, their feed. The invitation preferably takes the form of a unique uniform resource locator (URL). The creator can then share this URL in a number of ways including email, web sites, text messages, social media, and the like or any combination thereof. The URL, when followed, will take an individual to the creator's feed. The individual will then be directed to preferably one of two places. If the individual is not yet a user with the web or mobile application the invitee will be taken to page to create an account. If the individual has completed these steps previously, the user is directed to their manage subscriptions page where they can accept the invitation. In some instances, a user can opt out of a subscription after the fact by accessing the manage subscriptions page and selecting the same. This will remove a subscription from a user's feed.

In FIG. 5, a process is shown to send messages to subscribers of a particular feed by the feed creator. The feed creator must first record a prompt 800 they wish their subscribers to receive. Preferably, the creators will be able to use a system similar to other recorded greetings such as voicemail or automated messaging systems. By following a number of commands, the creator can ensure that the correct message is recorded and that the message can be heard clearly. The creator may be able to repeat the process until the message meets their specifications. The user may have to input a code to complete the message recording process. In a box 805, the system checks whether this code has been inputted. If the code has not, the recorded message may be stored as a draft 810. A draft message will be saved for a length of time in the system and may be editable upon access. If the system recognizes the completion of the recording process, the system will prompt the creator to schedule the delivery of the message 815.

The delivery system, as described in FIG. 1, will store the recorded message until the specifications put forth by the creator are met. Primarily, these specifications are date and time constraints as shown in box 820. The creator can choose at least a start and end date and a start and end time for attempted deliveries of the recorded message. There may also be an option to send immediately rather than a specific time. Once the delivery specifications are set, the user can then continue using the application or exit the application 825. When the specified time and date are reached, the message is delivered 830. The recorded message may be delivered just once, or may be delivered multiple times. The system may ask the user to input a code to receive the message. The receiver may also be able to store the message depending on their account capabilities or to replay the message if the message needs to be heard multiple times.

What is claimed is:

1. A method of managing broadcast messaging to individual subscribers or groups of subscribers comprising:
at least one user creating a new account to manage incoming and outgoing broadcast messages;
verifying the authenticity of the new account,
wherein verification is completed via response to an automated message and after a predetermined time a nonresponsive account is removed from the system;
receiving user preferences associated with the new account;
verifying the user has a verified phone number associated with their account;
generating an open or closed broadcast message in accordance with the user preferences,
wherein the open broadcast message can be subscribed to by any user and
the closed broadcast message can only be subscribed to by verified users;
providing a medium for the open or closed broadcast message to be transmitted.

2. The method of claim 1 further comprising repeating the creating step through the second verifying step for each user.

3. The method of claim 1 further comprising repeating the generating through monitoring step for each message input into the system.

4. The method of claim 1 further comprising monitoring the acceptance or declination of the open or closed broadcast message.

5. The method of claim 1 wherein a unique email and a unique user name are required to create a new user account.

6. The method of claim 5 wherein a unique phone number must be associated with the new user account.

7. A method of a user receiving broadcast messages via at least one electronic device comprising the steps of:
creating a new account to manage incoming broadcast messages;
subscribing to at least one broadcast message feed,
wherein the user may manually subscribe to the broadcast message feed or wherein the user may receive an invitation to subscribe to the broadcast message feed;
indicating the manner and mode of delivery of the broadcast messages;
receiving a notification of the broadcast messages from the at least one broadcast message feed; and
accessing the broadcast message via the at least one electronic device,
wherein the broadcast message may be audio, visual, or audiovisual in nature.

8. The method of claim 7 wherein subscribing to a broadcast message feed enables access to past broadcast messages distributed by that broadcast message feed.

9. The method of claim 7 wherein the broadcast message can be accessed using a lap top computer, desktop computer, PDA, gaming system, smart phone, or tablet or any combination thereof.

10. The method of claim 7 wherein the user can opt-out of certain subscribed broadcast message feeds.

11. The method of claim 7 wherein when the user can change notification preferences for each of the subscribed broadcast feeds individually at any time.

12. A method of creating a broadcast message feed comprising the steps of:
a user creating an account on a system website to manage the broadcast message feed;
creating a new broadcast message feed associated with the account,
wherein the broadcast message feed is assigned a unique URL and
wherein the broadcast message feed can be designated as open or closed; and
creating a new broadcast message to distribute to the subscribers of the new broadcast message feed.

13. The method of claim 12 further comprising the step of:
the user editing or modifying the broadcast message feed to conform to particular specifications.

14. The method of claim 12 wherein the new broadcast message is created by uploading an audio recording, text file, image file, sound file, or any combination thereof to the system website.

15. The method of claim 14 wherein the new broadcast message can be sent immediately or scheduled to be sent at a later time.
